(19) United States
(12) Patent Application Publication
(10) Pub. No.: US 2026/0074347 A1
(43) Pub. Date: Mar. 12, 2026

(54) BATTERY PACK

(71) Applicant: TOYOTA JIDOSHA KABUSHIKI KAISHA, Toyota-shi (JP)

(72) Inventors: Ryo MATSUDA, Nagoya-shi (JP); Yoshihiko Hiroe, Toyota-shi (JP)

(73) Assignee: TOYOTA JIDOSHA KABUSHIKI KAISHA, Toyota-shi (JP)

(21) Appl. No.: 19/098,064

(22) Filed: Apr. 2, 2025

(30) Foreign Application Priority Data
Sep. 6, 2024 (JP) 2024-154237

(51) Int. Cl. H01M 50/262; H01M 10/613; H01M 10/6554; H01M 50/209; H01M 50/271; H01M 50/289

(52) U.S. Cl. CPC H01M 50/262; H01M 10/613; H01M 10/6554; H01M 50/209; H01M 50/271; H01M 50/289

(57) ABSTRACT

A battery pack according to the present disclosure includes a battery case, a battery module, a first fastening member, a second fastening member, and a thermal conduction member. The battery case includes an upper case and a lower case. The battery module is stored in the battery case. The battery module includes a plurality of battery cells that is stacked in the battery module. The first fastening member is configured to fasten the top plate section of the upper case and the battery module. The second fastening member is configured to fasten the bottom plate section of the lower case and the battery module. The thermal conduction member is provided in contact with the upper surface of the battery module and the inner surface of the top plate section, between the battery module and the top plate section.

### CROSS-REFERENCE TO RELATED APPLICATION

This application claims priority to Japanese Patent Application No. 2024-154237 filed on Sep. 6, 2024. The disclosure of the above-identified application, including the specification, drawings, and claims, is incorporated by reference herein in its entirety.

### BACKGROUND

### 1. Technical Field

The present disclosure relates to a battery pack.

### 2. Description of Related Art

Japanese Unexamined Patent Application Publication No. 2024-076074 (JP 2024-076074 A) discloses a battery module in which a plurality of battery cells is disposed side by side in one direction. The battery module includes a pair of end plates. The end plates are disposed at both respective ends of the battery module in the one direction.

### SUMMARY

There is, however, room for improvement in the vibration resistance and the heat radiation performance of the battery module disclosed in JP 2024-076074 A.

The present disclosure has been devised in view of the problem. An object of the present disclosure is to provide a battery pack that makes it possible to increase the vibration resistance and the heat radiation performance of a battery module.

To solve the problem and achieve the object, a battery pack according to the present disclosure includes a battery case, a battery module, a plurality of first fastening members, a plurality of second fastening members, and a thermal conduction member. The battery case includes an upper case and a lower case. The battery module is stored in the battery case. The battery module includes a plurality of battery cells that is stacked in the battery module. The first fastening members are each configured to fasten the top plate section of the upper case and the battery module. The second fastening members are each configured to fasten the bottom plate section of the lower case and the battery module. The thermal conduction member is provided in contact with the upper surface of the battery module and the inner surface of the top plate section, between the battery module and the top plate section.

It is hereby possible to increase the vibration resistance and the heat radiation performance of the battery module in the battery pack according to the present disclosure in comparison with the battery module fastened and fixed to the lower case alone by each of the second fastening members because the battery module is further fastened and fixed to the upper case by each of the first fastening members.

In addition, two ribs extending in the longitudinal direction of the battery module may be provided on the inner surface of the top plate section in the width direction at an interval. The width direction is orthogonal to the longitudinal direction. The thermal conduction member may be disposed between the two ribs in the width direction.

It is hereby possible to restrain the position of the thermal conduction member from being deviated in the width direction of the battery module by vibration.

In addition, the battery module may include a pair of end plates. The end plates sandwich a plurality of battery cells in the stack direction. Each of the end plates and the upper case may be fastened by each of the first fastening members. Each of the end plates and the lower case may be fastened by each of the second fastening members.

It is hereby possible to easily secure the upper case and the lower case fastening portions for each of the first fastening members and each of the second fastening members to fasten the battery module.

In addition, each of the end plates may be divided into an upper end plate and a lower end plate in the height direction of the battery module. The upper end plate and the upper case may be fastened by each of the first fastening members. The lower end plate and the lower case may be fastened by each of the second fastening members. The upper end plate and the lower end plate may be coupled by an elastic member.

It is hereby possible to perform an operation of fastening the lower end plate and the lower case from the inside of the case by each of the second fastening members with the upper case detached from the lower case and an operation of fastening the upper end plate and the upper case from the inside of the case by each of the first fastening members.

A battery pack according to the present disclosure attains an effect of allowing the vibration resistance and the heat radiation performance of a battery module to increase.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a schematic configuration of a battery pack according to an embodiment from a side direction;

FIG. 2 is a sectional view of the battery pack according to a first embodiment;

FIG. 3 is a sectional view of a battery pack according to a second embodiment; and

FIG. 4 is a sectional view of a battery pack according to a third embodiment.

### DETAILED DESCRIPTION OF EMBODIMENTS

### First Embodiment

Hereinafter, a first embodiment of a battery pack according to the present disclosure will be described. It is to be noted that the present embodiment does not limit the present disclosure.

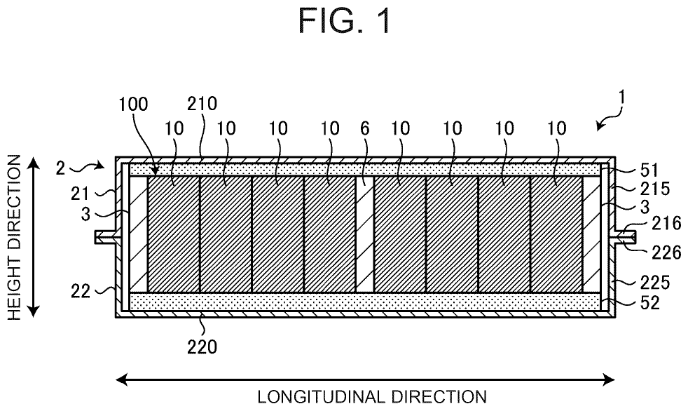

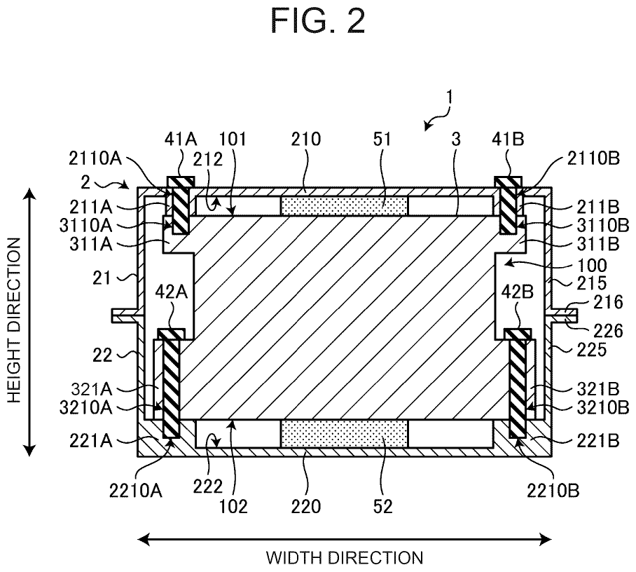

FIG. 1 is a sectional view of the schematic configuration of a battery pack 1 according to an embodiment from a side direction. The battery pack 1 according to the embodiment includes a battery module 100 stored in a battery case 2 including an upper case 21 and a lower case 22. FIG. 2 is a sectional view of the battery pack 1 according to the first embodiment.

The battery module 100 includes a plurality of battery cells 10, a pair of end plates 3, and an intermediate plate 6. Each of the battery cells 10 is, for example, a chargeable and dischargeable secondary battery such as a lithium-ion battery. In general, each of the battery cells 10 is formed to have a rectangular-parallelepiped shape. In general, the end plates 3 are members each shaped like a flat plate. The end plates 3 face each other with the battery cells 10 in between. The end plates 3 are connected to each other by an unillustrated band member extending in the longitudinal direction of the battery module 100 that is the stack direction of the battery cells 10. The battery module 100 is hereby retrained by the end plates 3 and a restraint member such as a band member. The intermediate plate 6 is provided such that the intermediate plate 6 partitions the battery cells 10 in the longitudinal direction of the battery module 100.

It is to be noted that the longitudinal direction of the battery module 100 is also described simply as the “longitudinal direction” in the present embodiment. In addition, the width direction of the battery module 100 orthogonal to the longitudinal direction is also described simply as the “width direction” in the present embodiment. In addition, the height direction of the battery module 100 orthogonal to the longitudinal direction and the width direction is also described simply as the “height direction” in the present embodiment. In addition, in the present embodiment, the longitudinal direction of the battery module 100 and the longitudinal direction of the battery pack 1 are the same direction. The width direction of the battery module 100 and the width direction of the battery pack 1 are the same direction. The height direction of the battery module 100 and the height direction of the battery pack 1 are the same direction.

The upper case 21 of the battery case 2 includes a top plate section 210, side plate sections 215, and flange sections 216. The upper case 21 forms a box shape that opens upward. The upper case 21 includes, for example, a metal material such as iron or aluminum. The top plate section 210 of the upper case 21 is formed, for example, to be shaped like a flat plate. The top plate section 210 is disposed above the battery module 100. As illustrated in FIG. 1 and FIG. 2, a thermal conduction member 51 is disposed in contact with an inner surface 212 of the top plate section 210 and an upper surface 101 of the battery module 100 between the top plate section 210 of the upper case 21 and the battery module 100 in the height direction. Additionally, it is sufficient if the thermal conduction member 51 is disposed in contact with the upper surfaces of the respective battery cells 10 and the inner surface 212 of the top plate section 210 at least between the battery cells 10 and the top plate section 210 of the upper case 21. The side plate sections 215 of the upper case 21 extend downward from the periphery of the top plate section 210 and surround the battery module 100. The flange sections 216 of the upper case 21 each have a shape that protrudes outward from the lower end of the side plate section 215.

The lower case 22 of the battery case 2 includes a bottom plate section 220, side plate sections 225, and flange sections 226. The lower case 22 forms a box shape that opens upward. The lower case 22 includes, for example, a metal material such as iron or aluminum. The bottom plate section 220 is disposed below the battery module 100. As illustrated in FIG. 1 and FIG. 2, a thermal conduction member 52 is disposed in contact with an inner surface 222 of the bottom plate section 220 and a lower surface 102 of the battery module 100 between the bottom plate section 220 of the lower case 22 and the battery module 100 in the height direction. Additionally, it is sufficient if the thermal conduction member 52 is disposed in contact with the lower surfaces of the respective battery cells 10 and the inner surface 222 of the bottom plate section 220 at least between the battery cells 10 and the bottom plate section 220 of the lower case 22. The side plate sections 225 of the lower case 22 stand from the periphery of the bottom plate section 220 and surround the battery module 100. The flange sections 226 of the lower case 22 each have a shape that protrudes outward from the upper end of the side plate section 225. The flange section 226 is fastened to the flange section 216 of the upper case 21 by an unillustrated fastening member such as a bolt.

As illustrated in FIG. 2, both ends of the upper section of each of the end plate 3 in the width direction are provided with a pair of upper flanges 311A, 311B. The upper flanges 311A, 311B protrude in the width direction. In addition, both ends of the lower section of each of the end plate 3 in the width direction are provided with a pair of lower flanges 321A, 321B. The lower flanges 321A, 321B protrude in the width direction.

The lower flanges 321A, 321B of the end plate 3 are provided with through-holes 3210A, 3210B extending through the lower flanges 321A, 321B in the height direction. In addition, the bottom plate section 220 of the lower case 22 is provided with lower bosses 221A, 221B on which the lower flanges 321A, 321B of the end plate 3 are placed. The lower bosses 221A, 221B are provided with the internal thread sections 2210A, 2210B to communicate with the through-holes 3210A, 3210B of the lower flanges 321A, 321B. Bolts 42A, 42B are then inserted to the through-holes 3210A, 3210B of the lower flanges 321A, 321B from above in the height direction and the bolts 42A, 42B are screwed into the internal thread sections 2210A, 2210B of the lower bosses 221A, 221B. The bolts 42A, 42B each serve as a second fastening member. The lower flanges 321A, 321B of the end plate 3 and the lower bosses 221A, 221B of the lower case 22 are hereby fastened by the bolts 42A, 42B and the end plate 3 is fixed to the lower case 22.

The upper flanges 311A, 311B of the end plate 3 are provided with internal thread sections 3110A, 3110B. In addition, the top plate section 210 of the upper case 21 is provided with upper bosses 211A, 211B at positions corresponding to the upper flanges 311A, 311B of the end plate 3. The upper bosses 211A, 211B are provided with through-holes 2110A, 2110B to communicate with the internal thread sections 3110A, 3110B of the upper flanges 311A, 311B. Bolts 41A, 41B are then inserted to the through-holes 2110A, 2110B of the upper case 21 from above (from the outside of the upper case 21) in the height direction and the bolts 41A, 41B are screwed into the internal thread sections 3110A, 3110B of the upper flanges 311A, 311B. The bolts 41A, 41B each serve as a first fastening member. The upper flanges 311A, 311B of the end plate 3 and the upper bosses 211A, 211B of the upper case 21 are hereby fastened by the bolts 41A, 41B and the end plate 3 is fixed to the upper case 21.

It is hereby possible to increase the battery pack 1 according to the first embodiment in rigidity in comparison with the battery module 100 fastened and fixed to the lower case 22 alone by the bolts 42A, 42B because the battery module 100 is further fastened and fixed to the upper case 21 by the bolts 41A, 41B. It is possible to reduce vibration in the battery module 100 in the height direction (vertical direction) and the width direction (horizontal direction).

In addition, when the top plate section 210 of the upper case 21 is considerably displaced by vibration, it may be difficult to bring the top plate section 210 of the upper case 21 and the thermal conduction member 51 into contact. Meanwhile, it is possible to restrain the top plate section 210 of the upper case 21 from being considerably displaced by vibration by fastening and fixing the top plate section 210 of the upper case 21 and the end plate 3 by the bolts 41A, 41B. It is hereby possible to maintain the upper case 21 and the thermal conduction member 51 in favorable contact in the battery pack 1 according to the first embodiment.

In addition, the battery pack 1 according to the first embodiment has a configuration in which the end plate 3 and the upper case 21 are fastened by the bolts 41A, 41B and the end plate 3 and the lower case 22 are fastened by the bolts 42A, 42B. It is hereby possible to easily secure the upper case 21 and the lower case 22 fastening portions for the bolts 41A, 41B, 42A, 42B to fasten the battery module 100 in the battery pack 1 according to the first embodiment.

In addition, in the battery pack 1 according to the first embodiment, heat radiation paths that each radiate heat from the battery module 100 are also formed on the upper case 21 side with the bolts 41A, 41B in between in addition to the lower case 22 side with the bolts 42A, 42B in between. It is possible to radiate more heat. For example, when any of the battery cells 10 of the battery module 100 abnormally generates heat, it is hereby possible to cause the battery cell 10 abnormally generating heat to radiate more heat to the battery case 2 and dissipate heat through the end plate 3 and the bolts 41A, 41B, 42A, 42B and prevent abnormal heat generation from being transferred to the other battery cells 10.

It is to be noted that the number of bolts that fasten the top plate section 210 of the upper case 21 and the end plate 3 is not limited to two. In addition, the number of bolts that fasten the bottom plate section 220 of the lower case 22 and the end plate 3 is not limited to two. In addition, in the battery pack 1 according to the first embodiment, the intermediate plate 6 may also be fastened and fixed to the top plate section 210 of the upper case 21 and the bottom plate section 220 of the lower case 22 by a fastening member such as a bolt in addition to the end plates 3.

### Second Embodiment

Hereinafter, a second embodiment of the battery pack according to the present disclosure will be described. It is to be noted that description similar to the description of the first embodiment will be omitted as appropriate in the present embodiment.

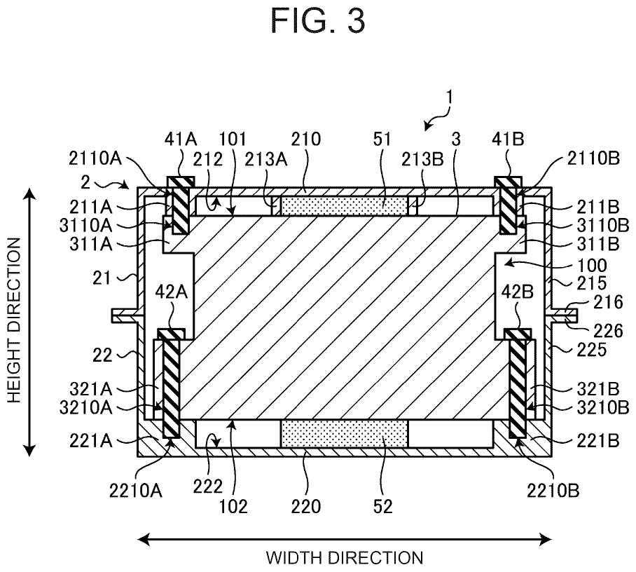

FIG. 3 is a sectional view of the battery pack 1 according to the second embodiment. As illustrated in FIG. 3, in the battery pack 1 according to the second embodiment, the battery pack 1 according to the first embodiment is provided with two ribs 213A, 213B on the inner surface 212 of the top plate section 210 of the upper case 21. The ribs 213A, 213B extend in the longitudinal direction of the battery module 100 (upper case 21). The thermal conduction member 51 provided between the upper surface 101 of the battery module 100 and the top plate section 210 of the upper case 21 is then disposed between the two ribs 213A, 213B in the width direction of the battery module 100.

It is hereby possible to define a space in which the thermal conduction member 51 is disposed by the top plate section 210 of the upper case 21, the upper surface 101 of the battery module 100, and the two ribs 213A, 213B. It is therefore possible to restrain the position of the thermal conduction member 51 from being deviated by vibration in comparison with the position of the thermal conduction member 51 deviated in the width direction of the battery module 100, in particular, in the absence of the two ribs 213A, 213B.

It is to be noted that the battery pack 1 according to the second embodiment may be provided with two ribs on the inner surface 222 of the bottom plate section 220 of the lower case 22 in the width direction at an interval and the thermal conduction member 52 may be disposed between the two ribs. The ribs extend in the longitudinal direction of the battery module 100 (lower case 22). It is hereby possible to define a space in which the thermal conduction member 52 is disposed by the bottom plate section 220 of the lower case 22, the lower surface of the battery module 100, and the two ribs. It is therefore possible to restrain the position of the thermal conduction member 52 from being deviated by vibration in comparison with the position of the thermal conduction member 52 deviated in the width direction of the battery module 100, in particular, in the absence of the two ribs on the bottom plate section 220 of the lower case 22.

### Third Embodiment

Hereinafter, a third embodiment of the battery pack according to the present disclosure will be described. It is to be noted that description similar to the description of the first embodiment will be omitted as appropriate in the present embodiment.

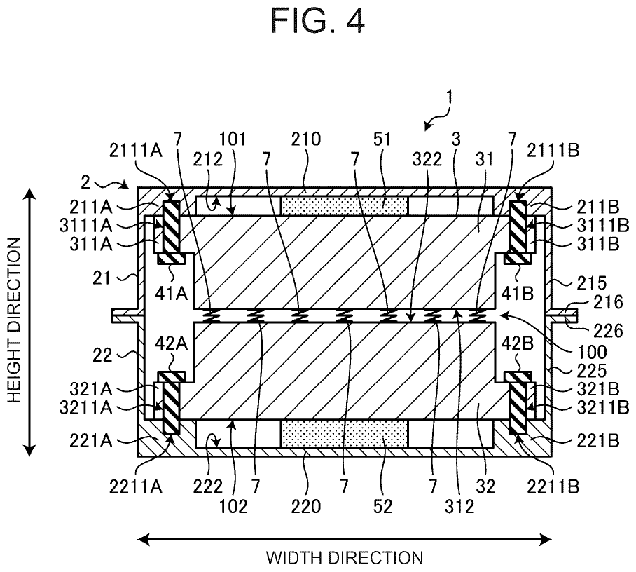

FIG. 4 is a sectional view of the battery pack 1 according to the third embodiment. In the battery pack 1 according to the third embodiment, the end plate 3 is divided into an upper end plate 31 and a lower end plate 32 in the height direction of the battery module 100. A lower surface 312 of the upper end plate 31 and an upper surface 322 of the lower end plate 32 are coupled by a plurality of springs 7 serving as a plurality of elastic members.

As illustrated in FIG. 4, both ends of the upper section of each of the upper end plate 31 in the width direction are provided with the upper flanges 311A, 311B protruding in the width direction. In addition, both ends of the lower section of each of the lower end plate 32 in the width direction are provided with the lower flanges 321A, 321B protruding in the width direction.

The upper flanges 311A, 311B of the upper end plate 31 are provided with through-holes 3111A, 3111B extending through the upper flanges 311A, 311B in the height direction. In addition, the top plate section 210 of the upper case 21 is provided with the upper bosses 211A, 211B on which the upper flanges 311A, 311B of the upper end plate 31 are placed. The upper bosses 211A, 211B are provided with internal thread sections 2111A, 2111B to communicate with the through-holes 3111A, 3111B of the upper flanges 311A, 311B. The bolts 41A, 41B are then inserted to the through-holes 3111A, 3111B of the upper flanges 311A, 311B from below in the height direction and the bolts 41A, 41B are screwed into the internal thread sections 2111A, 2111B of the upper bosses 211A, 211B. The upper flanges 311A, 311B of the upper end plate 31 and the upper bosses 211A, 211B of the upper case 21 are hereby fastened by the bolts 41A, 41B and the upper end plate 31 is fixed to the upper case 21.

The lower flanges 321A, 321B of the lower end plate 32 are provided with through-holes 3211A, 3211B extending through the lower flanges 321A, 321B in the height direction. In addition, the bottom plate section 220 of the lower case 22 is provided with the lower bosses 221A, 221B on which the lower flanges 321A, 321B of the lower end plate 32 are placed. The lower bosses 221A, 221B are provided with internal thread sections 2211A, 2211B to communicate with the through-holes 3211A, 3211B of the lower flanges 321A, 321B. The bolts 42A, 42B are then inserted to the through-holes 3211A, 3211B of the lower flanges 321A, 321B from above in the height direction and the bolts 42A, 42B are screwed into the internal thread sections 2211A, 2211B of the lower bosses 221A, 221B. The lower flanges 321A, 321B of the lower end plate 32 and the lower bosses 221A, 221B of the lower case 22 are hereby fastened by the bolts 42A, 42B and the lower end plate 32 is fixed to the lower case 22.

In the battery pack 1 according to the third embodiment, an operation of fastening, for example, the bottom plate section 220 of the lower case 22 and the lower end plate 32 from the inside of the case by the bolts 42A, 42B is performed with the upper case 21 detached from the lower case 22 (with the battery case 2 opened). Thereafter, the respective springs 7 of the end plate 3 are stretched out and the top plate section 210 of the upper case 21 and the upper end plate 31 are fastened from the inside of the case by the bolts 41A, 41B. It is to be noted that the order of the operation of fastening the bottom plate section 220 of the lower case 22 and the lower end plate 32 by the bolts 42A, 42B and the operation of fastening the top plate section 210 of the upper case 21 and the upper end plate 31 from the inside of the case by the bolts 41A, 41B may be reversed.

As described above, it is possible in the battery pack 1 according to the third embodiment to perform the operation of fastening the upper end plate 31 and the upper case 21 from the inside of the case by the bolts 41A, 41B and the operation of fastening the lower end plate 32 and the lower case 22 from the inside of the case by the bolts 42A, 42B.

What is claimed is:

1. A battery pack comprising:
a battery case including an upper case and a lower case;
a battery module stored in the battery case, the battery module including a plurality of battery cells that is stacked in the battery module;
a first fastening member configured to fasten a top plate section of the upper case and the battery module;
a second fastening member configured to fasten a bottom plate section of the lower case and the battery module; and
a thermal conduction member provided in contact with an upper surface of the battery module and an inner surface of the top plate section, between the battery module and the top plate section.

2. The battery pack according to claim 1, wherein:
two ribs extending in a longitudinal direction of the battery module are provided on the inner surface of the top plate section in a width direction at an interval, the width direction being orthogonal to the longitudinal direction; and
the thermal conduction member is disposed between the two ribs in the width direction.

3. The battery pack according to claim 1, wherein:
the battery module includes a pair of end plates, the end plates sandwiching a plurality of battery cells in a stack direction;
each of the end plates and the upper case are fastened by the first fastening member;
and
each of the end plates and the lower case are fastened by the second fastening member.

4. The battery pack according to claim 3, wherein:
each of the end plates is divided into an upper end plate and a lower end plate in a height direction of the battery module;
the upper end plate and the upper case are fastened by the first fastening member;
the lower end plate and the lower case are fastened by the second fastening member;
and
the upper end plate and the lower end plate are coupled by an elastic member.
